(19) United States
(12) Patent Application Publication
(10) Pub. No.: US 2014/0213316 A1
(43) Pub. Date: Jul. 31, 2014

(54) METHOD AND CORRESPONDING APPARATUS FOR POWER CONTROL

(71) Applicants: Jin Liu, Shanghai (CN); Yubo Yang, Shanghai (CN); Xudong Zhu, Shanghai (CN)

(72) Inventors: Jin Liu, Shanghai (CN); Yubo Yang, Shanghai (CN); Xudong Zhu, Shanghai (CN)

(73) Assignee: ALCATEL LUCENT, Paris (FR)

(21) Appl. No.: 14/239,024

(22) PCT Filed: Aug. 14, 2012
(86) PCT No.: PCT/IB2012/001892

§ 371 Date: Feb. 14, 2014

(30) Foreign Application Priority Data
Aug. 16, 2011 (CN) 201110235027.5

(51) Int. Cl. H04W 52/24; H04W 52/08

(52) U.S. Cl. CPC H04W 52/242; H04W 52/08
USPC 455/522

(57) ABSTRACT

According to the exemplary embodiments of the present invention, a wireless access point apparatus in a multi-point coordination system of a heterogeneous network obtains all pathlosses of all coordination micro wireless access points in a coordination set of a user equipment; obtains a real pathlosss from the user equipment to a macro wireless access point; calculates a virtual pathloss from a virtual user equipment corresponding to the user equipment to the macro wireless access point based on the obtained respective pathloss and; and informs the user equipment of information related to the computed virtual pathloss. A user equipment in a multi-point coordination system of a heterogeneous network receives information related to a virtual pathloss from a wireless access point acting as a scheduling network element; and performs power control using an uplink open-loop power control parameter for a macro wireless access point based on the information related to the virtual pathloss.

### TECHNICAL FIELD

The present application generally relates to a wireless communications technology, and more specifically, to a method and a corresponding apparatus for power control.

### DESCRIPTION OF THE RELATED ART

As having been defined in 3GPP TS36.213, the uplink (UL) power control in LTE (Long Term Evolution) comprises an open-loop mechanism in combination with a closed-loop mechanism, wherein the open-loop mechanism means that the transmit power of a user equipment (UE) is dependent on downlink (DL) pathlosss estimation, while the closed-loop mechanism means that a network may directly control the transmit power of the UE additionally through a downlink transmitted explicit power control command. An open-loop power control (OLPC) is primarily responsible for coarse adjustment of the UE's transmit power, which mainly compensates for slow change of pathloss, so as to obtain a certain averaged reception signal power for all users, while a closed-loop power control (CLPC) is primarily for adjustment of user-specific power settings, which can eliminate the impact of rapid channel change in a better way and match or approximate a receive SINR as much as possible, thereby further optimizing the overall performance of the network.

Based on the number of resource blocks (RB) scheduled to PUSCH transmission, the transmit power (i.e., uplink power) of the PUSCH in each subframe is derived from a semi-static operation point and a dynamic offset. In 3GPP, the power control equation for PUSCH transmission is defined as below:

P_{T}=min{Pₘₐₓ,10·log₁₀(M)+P₀+α·PL_{DL}+Δ_{MCS}+δ} 1)

wherein P_{T} denotes the transmit power in a given subframe, Pₘₐₓ denotes the maximum transmit power allowed by the UE, for example, 23 dBm, M denotes the PUSCH bandwidth measured by the number of physical resource blocks (PRB), and PL_{DL} denotes downlink pathloss measured by the UE.

Further, P₀ denotes an uplink transmit power base level, and a denotes an open-loop pathloss compensation factor, which is dependent on many factors including inter-cell interference and cell load.

P₀ further comprises: a cell-specific component P_{0C} which denotes a general power level for all UEs in the cell, and a UE-specific offset component P. The UE-specific offset component P_{0U} of the base level P₀ is issued to the UE by an eNB via upper-layer signaling, such that the eNB may correct a system offset in the UE's transmit power settings.

Besides, Δ_{MCS} is a component associated with a modulation and coding scheme (MCS), which reflects that different SINRs are needed for different modulation schemes and coding rates. δ is an UE-specific adjustment value instructed by an explicit TPC command, which denotes a UE-specific closed-loop power control (CLPC) correction value from the semi-static operation point.

What have been described above are the power control scheme in 3GPP. In a heterogeneous network, picocells are small and low-power wireless access points (AP), which are used to increase network capacity, extend macrocell coverage, and introduce new services. However, one of the major problems of co-channel deployment of the picocells lies in interference with a macrocell network or other picocells.

FIG. 1 shows an uplink transmission in a heterogeneous network.

As shown in FIG. 1, two scenarios which may cause serious uplink co-channel interference exist in the heterogeneous network. First, at an edge of a macro cell, a macro user equipment (MUE) transmits a signal to a macro wireless access point (Macro-eNB) with a relatively large transmit power, to thereby overcome a relatively large pathloss between the MUE and the macro wireless access point. In this scenario, if a pico wireless access point (Pico eNB, or RRH) RRH2 just exists at the cell edge, then the uplink signal transmitted by the MUE with a relatively large power will cause a very large interference with an uplink signal transmitted to the RRH2 by a pica user equipment (PUE) associated with the RRH2. Second, when a RRH, for example RRH1, is very close to the macro wireless access point in distance, the uplink signal transmitted by the PUE associated with the RRH1 may also generate a very great interference to an uplink signal transmitted by the MUE to the macro wireless access point.

In order to coordinate the co-channel interference in the above different scenarios, the uplink power control of a UE associated with a different RRH should have a different design purpose. For example, for the RRHs at the cell edge, the UEs associated with them should use a relatively large transmit power to overcome the interference from the MUE. For another example, for RRHs adjacent to the macro wireless access point, the UEs associated therewith should use a relatively low transmit power, so as to avoid serious interference to the MUE. It is seen that an adaptive adjustment of power control, for example, a RRH-dependent adjustment with respect to the location of the macro wireless access point, is relatively advantageous (J. Gora, K. I. Pedersen, A. Szufarska and S. Strzyz, “Cell-specific uplink power control for heterogeneous networks in LTE”, IEEE VTC2010-Fall, Ottawa, Canada, September 2010).

It is known that LTE uplink performance is sensitive to power control settings. As mentioned above, the uplink open-loop power control parameters include an uplink transmit power base level P₀ and pathloss compensation factor α. For macro cells and different picocells, a plurality of separate power setting schemes for uplink open-loop power control parameters have been studied in the prior art. However, these separate power setting mechanisms for cell-specific open-loop power control parameters in the prior art were proposed based on downlink pathloss PL_{DL} measured by the UE for its serving cell under the assumption of non-CoMP (coordinated multi-point) systems.

In a multi-cell reception of uplink multi-point coordination in a heterogeneous network, the above separate power control mechanisms for different access points cannot work well. That is because the UE's uplink data will be received by access points with different power settings, and the UE has different pathloss values PL for a plurality of access points connected thereto. Moreover, in a UE-specific clustering in the uplink multi-point coordination, the coordination areas of different UEs overlap and different coordination algorithms might be adopted. Thus, it would be difficult to execute cell-specific open-loop power control so as to satisfy the requirements of UEs having different coordination areas.

A mismatched power control may reduce multi-point coordinated gain significantly. In the prior art, the open-loop power control mechanism for a multi-point coordination system in a heterogeneous network has various kinds of deficiencies. For example, a CoMP system uplink power control solution was proposed in the document entitled “An effective uplink power control scheme in CoMP systems”, S. Yang, Q. Cui, X. Huang and X. Tao, IEEE VTC 2010-Fall, Ottawa, Canada, September 2010. However, that solution merely re-defines an effective pathloss as the maximum pathloss between a UE and all connection access points, without considering setting open-loop power control parameters. An improved CoMP system uplink power control scheme was also proposed in the document entitled “Performance analysis of an improved uplink power control method in LTE-A CoMP network”, Y. Ding, D. Xiao and D. Yang, IEEE IC-BNMT2010, October 2010. In that solution, the minimum P₀ of the CoMP clustering is selected as the final basic level, and the correction parameter of P₀ are used to optimize open-loop power settings. However, the solution does not reconsider the pathloss compensation factor α and the pathloss. Moreover, the above solutions failed to optimize all different CoMP processing and all different coordination areas.

### SUMMARY OF THE INVENTION

In order to solve the technical problems in the prior art, the present invention provides a uniform open-loop power control mechanism for all UEs within a macrocell coverage in a heterogeneous network having an uplink multi-point coordination processing. A virtual user equipment mapping scheme is adopted to adapt to different coordination areas and different coordination algorithms. Only limited signaling overhead is introduced at a user equipment to simplify calculation of transmit power.

According to one aspect of the present invention, there is provided a method for a wireless access point apparatus in a multi-point coordination system of a heterogeneous network, comprising: obtaining all pathlosses PL₁, . . . , PLₙ of all coordination pica wireless access points in a coordination set of a user equipment; obtaining a real pathlosss PL₀ from the user equipment to a macro wireless access point; calculating a virtual pathloss PL′₀ from a virtual user equipment corresponding to the user equipment to the macro wireless access point based on the obtained respective pathlosses PL₀ and PL₁, . . . , PLₙ; informing the user equipment of information related to the calculated virtual pathloss PL′₀.

According to another aspect of the present invention, there is provided a method for a user equipment in a multi-point coordination system of a heterogeneous network, comprising: receiving information related to a virtual pathlosss PL′₀ from a wireless access point as a scheduling network element; performing power control using uplink open-loop power control parameters for a macro wireless access point based on the information related to the virtual pathloss PL′₀.

According to a further aspect of the present invention, there is provided a wireless access point apparatus in a multi-point coordination system of a heterogeneous network, comprising: an obtaining module for obtaining all pathlosses PL₁, . . . , PLₙ of all coordination pico wireless access points in a coordination set of a user equipment and obtaining a real pathlosss PL₀ from the user equipment to a macro wireless access point; a calculating module for calculating a virtual pathloss PL′₀ from a virtual user equipment corresponding to the user equipment to the macro wireless access point based on the obtained respective pathlosses PL₀ and PL₁, . . . , PLₙ; and an informing module for informing the user equipment of information related to the calculated virtual pathloss PL′₀.

According to a still further aspect of the present invention, there is provided a user equipment in a multi-point coordination system for a heterogeneous network, comprising: a receiving module for receiving information related to a virtual pathlosss PL′₀ from a wireless access point acting as a scheduling network element; a power control module for performing power control using uplink open-loop power control parameters for a macro wireless access point based on the information related to the virtual pathloss PL′₀.

According to a yet further aspect of the present invention, there is provided a multi-point coordination system for a heterogeneous network, comprising a wireless access point apparatus according to the embodiments of the present invention, and a user equipment according to the embodiments of the present invention.

### BRIEF DESCRIPTION OF THE DRAWINGS

In order to understand the exemplary embodiments of the present invention in a better way, the following description will be made with reference to the accompanying drawings, wherein,

FIG. 1 illustrates uplink transmission in a heterogeneous network;

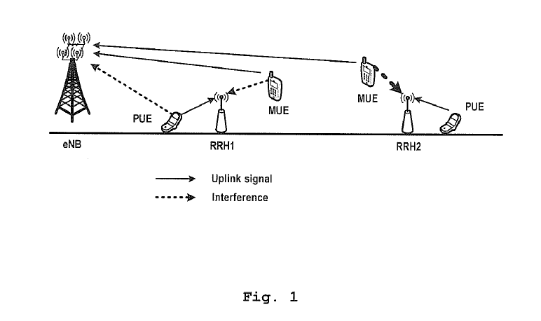

FIG. 2 illustrates a schematic diagram of heterogeneous network uplink multi-point coordination according to an exemplary embodiment of the present invention;

FIG. 3 illustrates a flow chart at a scheduling network element side according to an exemplary embodiment of the present invention;

FIG. 4 illustrates a flow chart at a user equipment side according to an exemplary embodiment of the present invention;

FIG. 5 illustrates an exemplary wireless access point apparatus according to an exemplary embodiment of the present invention;

FIG. 6 illustrates an exemplary user equipment apparatus according to an exemplary embodiment of the present invention.

### DETAILED DESCRIPTION OF THE PREFERRED EMBODIMENT

In the present invention, there is provided a uniform open-loop power control setting mechanism for all UEs within a macrocell coverage in a heterogeneous network having an uplink multi-point coordination processing. A virtual user equipment mapping scheme is adopted to adapt to different coordination areas and different coordination algorithms. Only limited signaling overhead is introduced at a user equipment to simplify computation of transmit power.

According to one embodiment of the present invention, any UE of Macro UEs and Pico UEs in a multi-point coordination system may be mapped to a virtual UE served by a macro cell only. In a power control, an uplink transmit power base level P₀ and an open-loop pathloss compensation factor α corresponding to the macro wireless access point (Macro-eNB) may be used for the virtual UE. With respect to a real pathloss PL₀ from the macro wireless access point to the UE, the virtual UE has a virtual pathloss PL′₀ from the Macro-eNB to the virtual UE. Thus, each UE working in the heterogeneous network multi-point coordination processing will be configured with a uniform open-loop power setting mechanism, just like the UE served by a macro-only network.

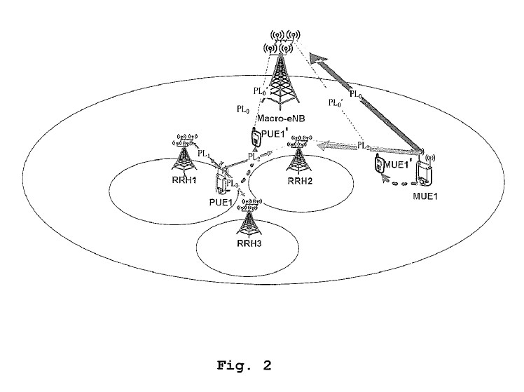

FIG. 2 illustrates a schematic diagram of heterogeneous network uplink multi-point coordination according to the exemplary embodiments of the present invention.

As shown in FIG. 2, the illustrated exemplary heterogeneous network comprises a macro cell and a plurality of pico cells, wherein the macro wireless access point of the macro cell is a Macro-eNB, and the pico wireless access points in the pico cells are RRH1, RRH2, and RRH3, respectively. In this heterogeneous network, the user equipment may comprise for example a macro user equipment MUE1 and a pico user equipment PUE1. In this example, the macro user equipment MUE1 performs multi-point coordination processing in the uplink direction via the macro wireless node Macro-eNB and the pico wireless access point RRH2; the pico user equipment PUE1 performs multi-point coordination processing via the pico wireless access points RRH1, RRH2, and RRH3.

The macro user equipment MUE1 is near the pico wireless access point RRH2, it incurs serious interference to the pico user equipment (pico-UE) associated with the pico wireless access point RRH2. According to one embodiment of the present invention, the macro-user equipment MUE1 may be served coordinately by the macro wireless access point Macro-eNB and the pico wireless access point RRH2, such that the macro user equipment MUE1 may be mapped to a virtual user equipment MUE1′, wherein the virtual user equipment is equivalent to being working in a system with the macro cell only. Thus, the corresponding virtual pathloss PL′₀ from the macro wireless access point Macro-eNB to the virtual user equipment MUE1′ is a function of a real pathloss PL₀ from the macro wireless access point Macro-eNB to the macro user equipment MUE and a real pathloss PL₂ from the pico wireless access point RRH2 to the macro user equipment MUE, i.e.,

PL′₀=ƒₘ(PL₀,PL₂) 2)

wherein the function ƒₘ(·) is dependent on a specific CoMP processing algorithm for the macro user equipment MUE1 in the system.

The pico user equipment PUE1 is located at an edge of the coverage of the pico wireless access point RRH1 and is not only near the pico wireless access point RRH2 but also near the pico wireless access point RRH3, and its uplink signal may be coordinately received by the pico wireless access points RRH1, RRH2, and RRH3 nearby. According to one embodiment of the present invention, the pico user equipment PUE1 may be mapped to a virtual user equipment PUE1′, wherein the virtual user equipment is equivalent to being working in a system with the macro cell only. Thus, its corresponding virtual pathloss PL′₀ from the macro wireless access point Macro-eNB to the virtual user equipment PUE1′ is a function of a real pathloss PL₀ from the macro wireless access point Macro-eNB to the pico user equipment PUE1 and real pathlosses PL₁, PL₂, and PL₃ from all coordinated wireless access points (i.e., the pico wireless access points RRH1, RRH2, and RRH3) to the pico user equipment PUE1, namely,

PL′₀=ƒₚ(PL₀,PL₁,PL₂,PL₃) 3)

wherein the function ƒ_{P}(·) is dependent on a specific CoMP processing algorithm for a pico user equipment PUE1.

To summarize the above equations 2) and 3), in order to realize uniform power setting to all user equipments in a heterogeneous network just like in a macro-only cell network system, a virtual pathloss PL′₀ from a macro wireless access point Macro-eNB to a virtual user equipment exists over a real pathloss PL₀ from the macro wireless access point Macro-eNB to the desired user equipment, which is given by the following equation:

PL′₀=ƒ(PL₀,PL₁, . . . PLₙ) 4)

wherein PL₁, . . . , PLₙ denote real pathlosses from the user equipment to respective pico wireless access points that perform multi-point coordination uplink transmission for the user equipment.

The function ƒ(·) is dependent on a specific CoMP processing algorithm for the user equipment in the system. For example, the function ƒ(·) may be selected from the following group: linear average function

$$\frac{{PL}_{0} + {PL}_{1} + … + {PL}_{n}}{n + 1} ,$$

harmonic average function

$$\frac{1}{\frac{1}{{PL}_{0}} + \frac{1}{{PL}_{1}} + … + \frac{1}{{PL}_{n}}} ,$$

etc. Selection of the function ƒ(·) may vary with the specific CoMP processing algorithm and the coordination set. Those skilled in the art may configure the required function ƒ(·) for a particular system in a manner of system simulation, so as to achieve the objective of optimizing system performance. According to the embodiments of the present invention, determination of the function ƒ(·) becomes an issue related to the implementation, which may be determined by device manufacturers or operators themselves.

It should be noted that the function of the virtual pathloss PL′₀ as provided in equation 1) is varies with a specific CoMP processing algorithm for the desired UE, and the function comprises the following two portions:
first portion: all pathlosses PL₁, . . . , PLₙ of all coordinated pico wireless access points in a coordination set corresponding to the UE, which reflects an effective received signal to interference plus noise ratio SINR at the associated point of the desired UE after CoMP processing;
second portion: the pathloss PL₀ from the macro wireless access point Macro-eNB to the desired UE, which reflects an interference level to the neighboring macro cell, no matter whether the macro-eNB is in the cooperating set of the desired UE or not.

For the desired UE, the pathloss information from all associated wireless access points in the cooperating set may be exchanged through a particular manner such as backhaul, a particular signaling, such that an access point serving as a scheduling network element can calculate the virtual pathloss PL′₀ of a virtual UE corresponding to the UE. In one implementation, the macro cell and picocells of the heterogeneous network share a same cell ID. In this scenario, it is the macro wireless access point Macro-eNB that calculates the virtual pathloss PL′₀ based on the equation 4) and informs it to the UE. In another embodiment, the macro cell and picocells in the heterogeneous network have their own cell IDs, respectively; in this scenario, besides the macro wireless access point, a pico access point RRH that provides multi-point coordination to the desired UE can also calculate the virtual pathloss PL′₀ based on equation 4) by and inform it to the UE. As such, the UE may perform an effective power control based on uplink open-loop power control parameters of the corresponding virtual UE, i.e., the uplink transmit power base level P₀ and the pathloss compensation factor α for the Macro-eNB, and in combination with the virtual pathloss PL′₀ corresponding to the virtual UE.

According to one preferred embodiment of the present invention, because the real pathlosss PL₀ from the macro wireless access point to the UE based on the 3GPP user equipment is known (for example, obtained through measurement at the UE side), the network element serving as a scheduling access point may only transmit a relative value between the virtual passloss PL′₀ and the real pathloss PL₀ to the UE via signaling, so as to reduce the required signaling load.

In one embodiment, the equation 4) may be denoted as:

PL′₀=ƒ(PL₀,PL₁, . . . PLₙ)=β·PL₀ 5)

wherein β denotes a ratio relationship between the real pathloss PL₀ and the virtual pathloss PL′₀. The network element serving as a scheduling access point may inform the calculated constant β to the UE as a UE dedicated parameter via a high-level signaling.

In one preferred embodiment, the equation 4) may be denoted as:

PL′₀=ƒ(PL₀,PL₁, . . . PLₙ)=PL₀+Δ 6)

wherein Δ denotes a difference relationship between the real pathloss PL₀ and the virtual pathloss PL₀. The network element serving as a scheduling access point may inform the calculated constant Δ to the UE as a UE-specific parameter via a higher-layer signaling.

Those skilled in the art should understand that the above examples are not restrictive. Any relative value that can reflect a relative value between a virtual pathloss PL′₀ and the real passloss PL₀ may also be selected to be signaled to the UE, as long as it can simplify the signaling and reduce signaling overhead.

Additionally, according to the embodiments of the present invention, the step of signaling the relative value between the virtual pathloss PL′₀ and the real pathloss PL₀ to the UE may not only be implemented in the above manner of directly transmitting the relative value via the higher-layer signaling, but also implemented by using an existing signaling system or by performing limited extension to the existing signaling system.

For example, in equation 1), the UE-specific offset component P_{0U} of the base level P₀ is issued to the UE by the eNB via the higher-layer signaling; δ is UE-specific and informed to the UE via dynamic signaling (explicit TPC command). Thus, in order to reduce modification to the existing signaling system, it may be considered to merge the above relative value into the UE-specific offset component P_{0U} of the base level P₀ or CLPC correction value δ, so as to inform the above relative value to the UE by using the existing signaling system or merely performing simple extension (of the number of bits).

For example, by placing the equation 5) into equation 1), the UE's power control may be expressed as:

$$\begin{matrix}{P}_{T} = min \{ {P}_{max} , 10 \cdot {log}_{10} ( M ) + {P}_{0 c} + {P}_{{0}_{U}} + α \cdot {PL}_{0} + {Δ}_{MCS} + δ \} \\ = min \{ {P}_{max} , 10 \cdot {log}_{10} ( M ) + {P}_{0 c} + {P}_{{0}_{U}} + α \cdot β \cdot {PL}_{0} + {Δ}_{MCS} + δ \} \\ = min \{ {P}_{max} , \begin{matrix}10 \cdot {log}_{10} ( M ) + {P}_{0 c} + ( {P}_{{0}_{U}} + α \cdot ( β - 1 ) \cdot {PL}_{0} ) + \\ α \cdot {PL}_{0} + {Δ}_{MCS} + δ\end{matrix} \} \\ = min \{ {P}_{max} , \begin{matrix}10 \cdot {log}_{10} ( M ) + {P}_{0 c} + {P}_{{0}_{U}} + α \cdot {PL}_{0} + {Δ}_{MCS} + \\ ( δ + α \cdot ( β - 1 ) \cdot {PL}_{0} )\end{matrix} \}\end{matrix}$$

Then, the virtual UE-specific offset component of the base level P₀, P_{0U}′=P_{0U}+α(β−1)PL₀, may be issued to the UE via higher-layer signaling; or the virtual CLPC correction value δ′=δ+α·(β−1)PL₀ may be informed to the UE through dynamic signaling (explicit TPC command).

For example, by placing equation 6) into equation 1), the UE's power control may be expressed as:

$$\begin{matrix}{P}_{T} = min \{ {P}_{max} , 10 \cdot {log}_{10} ( M ) + {P}_{0 c} + {P}_{{0}_{U}} + α \cdot {PL}_{0} + {Δ}_{MCS} + δ \} \\ = min \{ {P}_{max} , 10 \cdot {log}_{10} ( M ) + {P}_{0 c} + {P}_{{0}_{U}} + α \cdot ( {PL}_{0} + Δ ) + {Δ}_{MCS} + δ \} \\ = min \{ {P}_{max} , 10 \cdot {log}_{10} ( M ) + {P}_{0 c} + ( {P}_{{0}_{U}} + α \cdot Δ ) + α \cdot {PL}_{0} + {Δ}_{MCS} + δ \} \\ = min \{ {P}_{max} , 10 \cdot {log}_{10} ( M ) + {P}_{0 c} + {P}_{{0}_{U}} + α \cdot {PL}_{0} + {Δ}_{MCS} + ( δ + α \cdot Δ ) \}\end{matrix}$$

Then, the virtual UE-specific offset component of the base level P₀, P_{0U}′=P_{0U}+α·Δ, may be issued to the UE via higher-layer signaling; or the virtual CLPC correction value δ′=δ+α·Δ may be informed to the UE via dynamic signaling (explicit TPC command).

It should be understood that according to the technical solution of the present invention, any other solution known to those skilled in the art may be adopted to issue the information related to the virtual pathloss PL′₀ to the UE. For example, a power control increment as calculated according to the embodiments of the present invention may be partially transmitted to the UE via higher-layer signaling through the UE-specific offset component of abase level P₀, and partially transmitted to the UE via dynamic signaling through the virtual CLPC correction value, and so forth. Thus, the specific manner of informing the UE does not constitute a limitation to the present invention.

According to the embodiments of the present invention, within the macro coverage of the heterogeneous network, open-loop power control parameters which are set uniform may be achieved for all users, just like these UEs in a system of a macro-only cell. Specific computation functions for different CoMP processing algorithms and virtual pathloss PL′₀ in different coordination sets are transparent to the desired UE. In other words, the network element serving as a scheduling access point merely signals the calculated virtual pathloss PL′₀, preferably the relative value between the virtual pathloss PL′₀ and the real pathloss PL₀ to the UE.

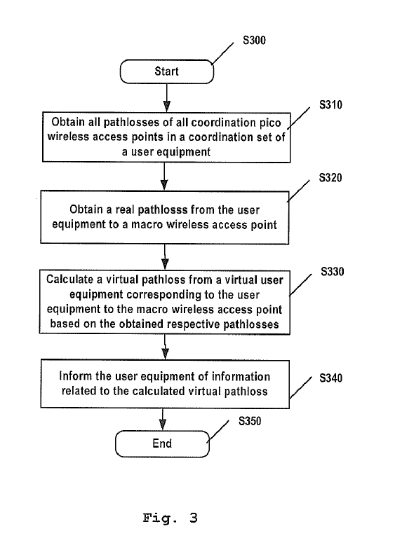

FIG. 3 illustrates a flow chart at a scheduling network element side according to the exemplary embodiments of the present invention.

As illustrated in FIG. 3, in step 300, the process starts.

In step S310, in a heterogeneous network, a wireless access point serving as a scheduling network element of the desired UE obtains all pathlosses PL₁, . . . , PLₙ of all coordination pico wireless access points in a coordination set of the UE.

The UE's scheduling element may be a macro wireless access node or a pico wireless access node. For example, in one implementation, the macro cell and picocells in a heterogeneous network share the same cell ID. In this scenario, the macro wireless access point macro-eNB may act as the UE's scheduling network element. In another implementation, the macro cell and picocells of the heterogeneous network have their own cell ID. In this scenario, a macro wireless access point may act as the scheduling network element, or a pico wireless access point RRH which provides multi-point coordination for the desired UE may act as the scheduling network element. Here, for the sake of convenience, the scheduling network work element refers to the wireless access point which is in charge of scheduling UE power control in the present invention, without further differentiating specific configurations of scenarios and networks. Those skilled in the art would appreciate that the technical solution of the present invention is easily implemented in a macro wireless access node or a pico wireless access node in the heterogeneous network, or in both, which will not constitute a limitation to the technical solution of the present invention, because these schemes are various kinds of transformations of the embodiments of the present invention.

All pathlosses PL₁, . . . , PLₙ corresponding to all coordination pico wireless access points in the coordination set of the UE are measured for the UE by all coordination access points in the coordination set of the UE, respectively, and may be exchanged in any known manner in the art. For example, in one implementation, each pico wireless access point may transmit a pathloss to the scheduling element via for example a backhaul. In another implementation, each pico wireless access node may transmit a pathloss to the scheduling network element via a specific signaling.

In step S320, the scheduling network element obtains a pathloss PL₀ from the UE to the macro wireless access point.

According to one embodiment of the present invention, the pathloss PL₀ from the macro wireless access point to the UE is measured by the macro wireless access point. Therefore, in a preferred embodiment, a real pathloss PL₀ may be obtained from the macro wireless access point. In another embodiment, the pathloss PL₀ from the macro wireless access point to the UE is measured by the UE. Therefore, in one implementation, the real pathloss PL₀ from the macro wireless access point to the UE may be reported by the UE to the scheduling network element.

In step S330, the scheduling network element calculates a virtual pathloss PL′₀ from a virtual UE corresponding to the UE to the macro wireless access point based on each obtained pathloss.

The virtual pathloss PL′₀ may be expressed as:

PL′₀=ƒ(PL_{O},PL₁, . . . PLₙ)

wherein, the function ƒ(·) is dependent on the specific CoMP processing algorithm for the UE in the system. For example, the function ƒ(·) may be selected from the following group: linear average function

$$\frac{{PL}_{0} + {PL}_{1} + … + {PL}_{n}}{n + 1} ,$$

harmonic average function

$$\frac{1}{\frac{1}{{PL}_{0}} + \frac{1}{{PL}_{1}} + … + \frac{1}{{PL}_{n}}} ,$$

etc. Selection of the function ƒ(·) may vary with the specific CoMP processing algorithm and the coordination set. Those skilled in the art may configure the required function ƒ(·) for a particular system in a manner of system simulation and the like, so as to achieve the objective of optimizing system performance. According to the embodiments of the present invention, determination of the function ƒ(·) becomes an issue related to the implementation, which may be determined by device manufacturers or operators themselves.

Alternatively, the scheduling network element may further calculate a relative value between the real pathloss PL₀ and the virtual pathloss PL′₀. For example, β value representing the ratio relationship between the real pathloss PL₀ and the virtual pathloss PL′₀. For another example, Δ value representing the difference relationship between the real pathloss PL₀ and the virtual pathloss PL′₀

Alternatively, the scheduling network element may further calculate the virtual UE-specific offset component P_{0U}′ of the base level P₀ or the virtual correction value δ′ based on the relative value between the calculated virtual pathloss PL′₀ and the real pathloss PL₀, which will be described in detail with reference to step S340.

In step S340, the scheduling network element informs the user equipment of information related to the calculated virtual pathloss PL′₀.

According to 3GPP, because the UE's real pathloss PL₀ from the macro wireless access point to the UE is known (for example, obtained by measurement at the UE side), the network element serving as a scheduling access point may merely signal the relative value between the virtual pathloss PL′₀ and the real pathloss PL₀ to the UE so as to reduce the required signaling overhead. For example, the scheduling network element may merely signal the value β or the value Δ as set forth above to the UE. Of course, those skilled in the art would appreciate that other parameter (s) may be employed to represent information related to the virtual pathloss PL′₀.

Besides, according to the embodiments of the present invention, the step of signaling the relative value between the virtual pathloss PL′₀ and the real pathloss PL₀ to the UE may not only be implemented in the above manner of directly transmitting the relative value via the higher-layer signaling, but also implemented in the existing manner or by performing limited extension to the existing signaling.

For example, in equation 1), the UE-specific offset component P_{0U} of the base level P₀ is issued to the UE by the eNB via a higher-layer signaling; δ is UE-specific and informed to the UE via dynamic signaling (for example, explicit TPC command). Thus, in order to reduce modification to the existing signaling system, it may be further considered to merge the above relative value into the UE-specific offset component P_{0U} of a base level P₀ or CLPC correction value δ, so as to inform the above relative value to the UE by using the existing signaling system or merely performing simple extension (of the number of bits).

For example, by placing the equation 5) into equation 1), the UE's power control may be expressed as:

$$\begin{matrix}{P}_{T} = min \{ {P}_{max} , 10 \cdot {log}_{10} ( M ) + {P}_{0 c} + {P}_{{0}_{U}} + α \cdot {PL}_{0} + {Δ}_{MCS} + δ \} \\ = min \{ {P}_{max} , 10 \cdot {log}_{10} ( M ) + {P}_{0 c} + {P}_{{0}_{U}} + α \cdot β \cdot {PL}_{0} + {Δ}_{MCS} + δ \} \\ = min \{ {P}_{max} , \begin{matrix}10 \cdot {log}_{10} ( M ) + {P}_{0 c} + ( {P}_{{0}_{U}} + α \cdot ( β - 1 ) \cdot {PL}_{0} ) + \\ α \cdot {PL}_{0} + {Δ}_{MCS} + δ\end{matrix} \} \\ = min \{ {P}_{max} , \begin{matrix}10 \cdot {log}_{10} ( M ) + {P}_{0 c} + {P}_{{0}_{U}} + α \cdot {PL}_{0} + {Δ}_{MCS} + \\ ( δ + α \cdot ( β - 1 ) \cdot {PL}_{0} )\end{matrix} \}\end{matrix}$$

Then, the virtual UE-specific offset component of the base level P₀, P_{0U′}=P_{0U}+α(β−1)·PL₀, may be issued to the UE via higher-layer signaling; or the virtual CLPC correction value δ′=δ+α·(β−1)PL₀ may be informed to the UE through dynamic signaling (for example, explicit TPC command).

For another example, by placing equation 6) into equation 1), the UE's power control may be expressed as:

$$\begin{matrix}{P}_{T} = min \{ {P}_{max} , 10 \cdot {log}_{10} ( M ) + {P}_{0 c} + {P}_{{0}_{U}} + α \cdot {PL}_{0} + {Δ}_{MCS} + δ \} \\ = min \{ {P}_{max} , 10 \cdot {log}_{10} ( M ) + {P}_{0 c} + {P}_{{0}_{U}} + α \cdot ( {PL}_{0} + Δ ) + {Δ}_{MCS} + δ \} \\ = min \{ {P}_{max} , 10 \cdot {log}_{10} ( M ) + {P}_{0 c} + ( {P}_{{0}_{U}} + α \cdot Δ ) + α \cdot {PL}_{0} + {Δ}_{MCS} + δ \} \\ = min \{ {P}_{max} , 10 \cdot {log}_{10} ( M ) + {P}_{0 c} + {P}_{{0}_{U}} + α \cdot {PL}_{0} + {Δ}_{MCS} + ( δ + α \cdot Δ ) \}\end{matrix}$$

Then, the virtual UE-specific offset component of the base level P₀, P_{0U}′=P_{0U}+α·Δ, may be issued to the UE via higher-layer signaling; or the virtual CLPC correction value δ′=δα·Δ may be informed to the UE via dynamic signaling (for example, explicit TPC command).

It should be understood that according to the technical solution of the present invention, any other solution known to those skilled in the art may be adopted to issue the information related to the virtual pathloss PL′₀ to the UE. For example, a power control increment as calculated according to the embodiments of the present invention may be partially transmitted to the UE via higher-layer signaling through the UE-specific offset component of a base level P₀, and partially transmitted to the UE via dynamic signaling through the virtual CLPC correction value, and so forth. Thus, the specific manner of informing the UE does not constitute a limitation to the present invention.

In step S350, the process ends.

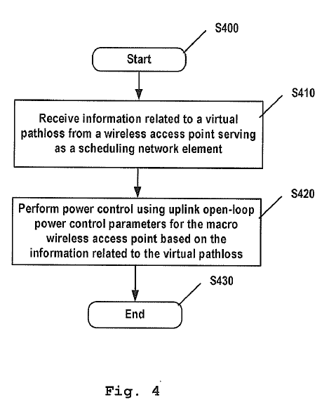

FIG. 4 illustrates a flowchart at a user equipment side according to the exemplary embodiments of the present invention.

As illustrated in FIG. 4, in step S400, the process starts.

In step S410, a user equipment receives from a scheduling network element information related to a virtual pathloss PL′₀.

For example, the user equipment may receive from a scheduling network element a signaled relative value between the virtual pathloss PL′₀ and a real pathloss PL₀, for example, the value β or Δ, thereby being capable of determining the virtual pathloss PL′₀ based on the PL₀ measured at the UE side.

Alternatively, the user equipment may receive from the scheduling network element a virtual UE-specific offset component P_{0U′} of abase level P₀ as issued via a higher-layer signaling; or the user equipment may receive from the scheduling network element a virtual CLPC correction value δ′ via dynamic signaling, wherein:

when the calculated relative value is δ,

P_{0U′}=P_{0U}+α·(β−1)·PL₀;

and

δ′=δ+α·(β−1)·PL₀.

When the calculated relative value is Δ,

P_{0U}′=P_{0U}+α·Δ;

and

δ′=δ+α·Δ.

In step S420, the user equipment uses uplink open-loop power control parameters for the macro wireless access point to perform power control based on the information related to the virtual pathloss PL′₀.

In this step, the uplink open-loop power control parameters comprise an uplink transmit power base level P₀ for the macro wireless access point and a pathloss compensation factor α.

In one embodiment, the relative value β or Δ between the virtual pathloss PL′₀ and the real pathloss PL₀ is issued via the higher-layer signaling directly and therefore the user equipment determines the virtual pathloss PL′₀. In that case, power control is performed by using the virtual pathloss PL′₀ and the uplink open-loop power control parameters for the macro wireless access point, namely:

P_{T}=min{Pₘₐₓ,10·log₁₀(M)+P_{0c}+P_{0U}+α·PL₀′+Δ_{MCS}+δ}

In one embodiment, P_{0U′} based on the value β or Δ is issued via the higher-layer signaling. In that case, power control is performed by using P_{0U′} and the uplink open-loop power control parameters for the macro wireless access point, namely:

P_{T}=min{Pₘₐₓ,10·log₁₀(M)+P_{0c}+P_{0U}′+α·PL₀+Δ_{MCS}+δ}.

In one embodiment, if δ′ based on the value β or Δ is issued via dynamic signaling, power control is performed by using δ′ and the uplink open-loop power control parameters for the macro wireless access point, namely:

P_{T}=min{Pₘₐₓ,10·log₁₀(M)+P_{0c}+P_{0U}+α·PL_{0U}+Δ_{MCS}+δ′}.

In step S430, the process ends.

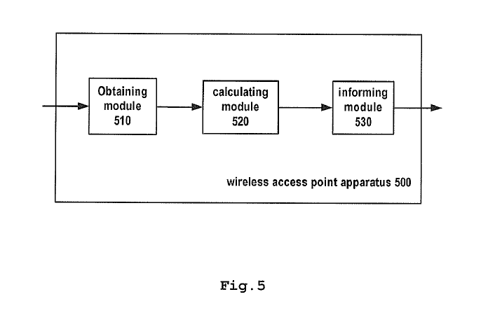

FIG. 5 illustrates an exemplary wireless access point apparatus according to the exemplary embodiments of the present invention.

As illustrated in FIG. 5, a wireless access point apparatus 500 according to one embodiment of the present invention comprises an obtaining module 510, a calculating module 520, and an informing module 530.

The obtaining module 510 obtains all pathlosses PL₁, . . . , PLₙ of all coordination pico wireless access points in a coordination set of a user equipment. The all pathlosses PL₁, . . . , PLₙ corresponding to all coordination pico wireless access points in the coordination set of the UE are measured for the UE by all coordination access points in the coordination set of the UE, respectively, and may be exchanged in any known manner in the art. For example, in one implementation, the obtaining module 510 may obtain corresponding pathloss from each pico wireless access node through for example a backhaul. In another implementation, the obtaining module 510 may obtain a pathloss from each pico wireless access node via a specific signaling.

The obtaining module 510 further obtains the pathloss PL₀ from the UE to the macro wireless access point. According to one embodiment of the present invention, the pathloss PL₀ from the macro wireless access point to the UE is measured by the macro wireless access point. Thus, in a preferred implementation, the real pathloss may be obtained from the macro wireless access point. In another embodiment, the pathloss PL₀ from the macro wireless access point to the UE is measured by the UE. Therefore, in one implementation, the real pathloss PL₀ from the macro wireless access point to the UE may be reported by the UE to the scheduling network element.

The calculating module 520 calculates a virtual pathloss PL′₀ from a virtual UE corresponding to the UE to the macro wireless access point based on the pathlosses obtained by the obtaining module 520.

The virtual pathloss PL′₀ may be expressed as:

PL′₀=ƒ(PL₀,PL₁, . . . PLₙ)

wherein, the function ƒ(·) is dependent on the specific CoMP processing algorithm for the UE in the system. For example, the function ƒ(·) may be selected from the following group: linear average function

$$\frac{{PL}_{0} + {PL}_{1} + … + {PL}_{n}}{n + 1} ,$$

harmonic average function

$$\frac{1}{\frac{1}{{PL}_{0}} + \frac{1}{{PL}_{1}} + … + \frac{1}{{PL}_{n}}} ,$$

etc. Selection of the function ƒ(·) may vary with the specific CoMP processing algorithm and the coordination set. Those skilled in the art may configure the required function ƒ(·) for a particular system in a manner of system simulation and the like, so as to achieve the objective of optimizing system performance. According to the embodiments of the present invention, determination of the function ƒ(·) becomes an issue related to the implementation, which may be determined by device manufacturers or operators themselves.

Alternatively, the calculating module 520 may further calculate a relative value between the real pathloss PL₀ and the virtual pathloss PL′₀. PL′₀. For In an example, the relative value is a value β value representing the ratio relationship between the real pathloss PL₀ and the virtual pathloss PL). In another example, the relative value is a value Δ value representing the difference relationship between the real pathloss PL₀ and the virtual pathloss PL′₀.

Alternatively, the calculating module 520 may further calculate, based on the relative value between the calculated virtual pathloss PL′₀ and the real pathloss PL₀, the virtual UE-specific offset component P_{0U}′ of the base level P₀ or the virtual correction value δ′, which will be described in detail with reference to the informing module 530.

The informing module 530 informs the UE of information related to the calculated virtual pathloss PL′₀.

Alternatively, the informing module 530 may only inform the UE of the above value β or Δ in higher-layer signaling, such that the UE can obtain the virtual pathloss PL′₀ based on the measured real pathloss PL₀, thereby reducing the required signaling overhead.

Additionally, according to the embodiments of the present invention, the step of signaling the relative value between the virtual pathloss PL′₀ and the real pathloss PL₀ to the UE may not only be implemented in the above manner of directly transmitting the relative value via the higher-layer signaling, but also implemented in the existing manner or by performing limited extension to the existing signaling.

For example, in equation 1), the UE-specific offset component P_{0U} of the base level P₀ is issued to the UE by the eNB via a higher-layer signaling; δ is UE-specific and informed to the UE via dynamic signaling (for example, explicit TPC command). Thus, in order to reduce modification to the existing signaling system, it may be further considered to merge the above relative value into the UE-specific offset component P_{0U} of a base level P₀ or CLPC correction value δ, so as to inform the above relative value to the UE by using the existing signaling system or merely performing simple extension (of the number of bits).

For example, by placing the equation 5) into equation 1), the UE's power control may be expressed as:

$$\begin{matrix}{P}_{T} = min \{ {P}_{max} , 10 \cdot {log}_{10} ( M ) + {P}_{0 c} + {P}_{{0}_{U}} + α \cdot {PL}_{0} + {Δ}_{MCS} + δ \} \\ = min \{ {P}_{max} , 10 \cdot {log}_{10} ( M ) + {P}_{0 c} + {P}_{{0}_{U}} + α \cdot β \cdot {PL}_{0} + {Δ}_{MCS} + δ \} \\ = min \{ {P}_{max} , \begin{matrix}10 \cdot {log}_{10} ( M ) + {P}_{0 c} + ( {P}_{{0}_{U}} + α \cdot ( β - 1 ) \cdot {PL}_{0} ) + \\ α \cdot {PL}_{0} + {Δ}_{MCS} + δ\end{matrix} \} \\ = min \{ {P}_{max} , \begin{matrix}10 \cdot {log}_{10} ( M ) + {P}_{0 c} + {P}_{{0}_{U}} + α \cdot {PL}_{0} + {Δ}_{MCS} + \\ ( δ + α \cdot ( β - 1 ) \cdot {PL}_{0} )\end{matrix} \}\end{matrix}$$

Then, the virtual UE-specific offset component of the base level P₀, P_{0U}′=P_{0U}+α·(β−1)·PL₀, may be issued to the UE via higher-layer signaling; or the virtual CLPC correction value δ′=δ+α·(β−1)PL₀ may be informed to the UE through dynamic signaling (for example, explicit TPC command).

For another example, by placing equation 6) into equation 1), the UE's power control may be expressed as:

$$\begin{matrix}{P}_{T} = min \{ {P}_{max} , 10 \cdot {log}_{10} ( M ) + {P}_{0 c} + {P}_{{0}_{U}} + α \cdot {PL}_{0} + {Δ}_{MCS} + δ \} \\ = min \{ {P}_{max} , 10 \cdot {log}_{10} ( M ) + {P}_{0 c} + {P}_{{0}_{U}} + α \cdot ( {PL}_{0} + Δ ) + {Δ}_{MCS} + δ \} \\ = min \{ {P}_{max} , 10 \cdot {log}_{10} ( M ) + {P}_{0 c} + ( {P}_{{0}_{U}} + α \cdot Δ ) + α \cdot {PL}_{0} + {Δ}_{MCS} + δ \} \\ = min \{ {P}_{max} , 10 \cdot {log}_{10} ( M ) + {P}_{0 c} + {P}_{{0}_{U}} + α \cdot {PL}_{0} + {Δ}_{MCS} + ( δ + α \cdot Δ ) \}\end{matrix}$$

Then, the virtual UE-specific offset component of the base level P₀, P_{0U}′=P_{0U}+α·Δ, may be issued to the UE via higher-layer signaling; or the virtual CLPC correction value δ′=δ+α·Δ may be informed to the UE via dynamic signaling (for example, explicit TPC command).

Alternatively, the informing module 530 may inform the UE of the virtual UE-specific offset component P_{0U′} of the base level P₀ in a higher-layer signaling, or inform the UE of the virtual CLPC correction value δ′ in a dynamic signaling manner, thereby fully utilizing the existing signaling system or it is only required to perform limited extension to the existing signaling system.

It should be understood that according to the technical solution of the present invention, any other solution known to those skilled in the art may be adopted to issue the information related to the virtual pathloss PL′₀ to the UE. For example, a power control increment as calculated according to the embodiments of the present invention may be partially transmitted to the UE via higher-layer signaling through the UE-specific offset component of abase level P₀, and partially transmitted to the UE via dynamic signaling through the virtual CLPC correction value, and so forth. Thus, the specific manner of informing the UE does not constitute a limitation to the present invention.

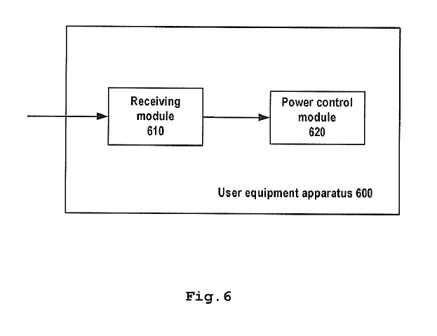

FIG. 6 illustrates an exemplary user equipment apparatus according to the exemplary embodiments of the present invention.

As illustrated in FIG. 6, a user equipment apparatus 600 according to one embodiment of the present invention comprises: a receiving module 610 and a power control module 620.

The receiving module 610 receives from a scheduling network element information related to a virtual pathloss PL′₀

For example, the user equipment may receive from the scheduling network element a signaled relative value between the virtual pathloss PL′₀ and a real pathloss PL₀, for example, the value β or Δ as set forth above, thereby being capable of determining the virtual pathloss PL′₀ based on the PL₀ measured at the UE side.

Alternatively, the user equipment may receive from the scheduling network element a virtual UE-specific offset component P_{0U}′ of a base level P₀ as issued via a higher-layer signaling; or the user equipment may receive from the scheduling network element a virtual CLPC correction value δ′ via dynamic signaling, wherein:

when the calculated relative value is β,

P_{0U}′=P_{0U}+α·(β−1)·PL₀;

and

δ′=δ+α·(δ−1)·PL₀.

When the calculated relative value is Δ,

P_{0U}′=P_{0U}+α·Δ;

and

δ′=δ+α·Δ,

The power control module 620 performs power control using the uplink open-loop power control parameters for a macro wireless access point based on the information related to the virtual pathloss PL′₀.

Here, the uplink open-loop power control parameters comprise an uplink transmit power base level P₀ for the macro wireless access point and a pathloss compensation factor α.

In one embodiment, the relative value β or Δ between the virtual pathloss PL′₀ and the real pathloss PL₀ is issued via the higher-layer signaling directly and therefore the user equipment determines the virtual pathloss PL′₀. In that case, the power control module performs power control using the virtual pathloss PL′₀ and the uplink open-loop power control parameters for the macro wireless access point, namely:

P_{T}=min{Pₘₐₓ,10·log₁₀(M)+P_{0c}+P_{0U}+α·PL₀′+Δ_{MCS}+δ}.

In one embodiment, P_{0U}′ based on the value β or Δ is issued via the higher-layer signaling. In that case, power control module 620 performs power control using P_{0U}′ and the uplink open-loop power control parameters for the macro wireless access point, namely:

P_{T}=min{Pₘₐₓ,10·log₁₀(M)+P_{0c}+P_{0U}′+α·PL₀+Δ_{MCS}+δ}.

In one embodiment, if δ′ based on the value β or Δ is issued via dynamic signaling, then the power control module 620 performs power control using δ′ and the uplink open-loop power control parameters for the macro wireless access point, namely:

P_{T}=min{Pₘₐₓ,10·log₁₀(M)+P_{0c}+P_{0U}+α·PL₀+Δ_{MCS}+δ′}.

It should be understood that according to the technical solution of the present invention, any other solution known to those skilled in the art may be adopted to issue the information related to the virtual pathloss PL′₀ to the UE. For example, a power control increment as calculated according to the embodiments of the present invention may be partially transmitted to the UE via higher-layer signaling through the UE-specific offset component of abase level P₀, and partially transmitted to the UE via dynamic signaling through the virtual CLPC correction value, and so forth. Thus, the specific manner of informing the UE does not constitute a limitation to the present invention.

From the above description, it is seen that the user equipment apparatus 600 can obtain the virtual pathloss based on the received signaling without knowing how to calculate the virtual pathloss, and perform power control based on the uplink open-loop power control parameters and the virtual pathloss in a uniform manner. Thus, such processing transparent to the user equipment does not increase the apparatus complexity and processing overhead of the user equipment apparatus 600.

It should be understood that FIGS. 5 and 6 merely illustrate modules/units closely associated with the technical solutions of the present invention. The wireless access point apparatus and user equipment may also comprise any functional modules/units capable of implementing their respective functionality. These functional modules/units are known to those skilled in the art, and thus their descriptions are omitted here.

The embodiments of the present invention may be implemented in software, hardware, application logic, or a combination of software, hardware, and application logic. The software, application logic and/or hardware may reside in a base station, an access point, or a similar network device. Where necessary, apart of the software, application logic and/or hardware may reside in the access point, while a part of software, application logic and/or hardware may reside in a network element such as a base station. In the exemplary embodiments, the application logic, software, or instruction set are maintained on any of various kinds of conventional computer readable mediums. In the context of the present invention, “a computer readable medium” may any medium or apparatus capable of containing, storing, conveying, propagating, or transmitting instructions available to an instruction execution system, apparatus or device such as a computer system or associated with the instruction execution system, apparatus or device such as a computer system. The computer readable medium may comprise a computer-readable memory medium that can be any medium or apparatus capable of containing or storing instructions available to an instruction execution system, apparatus or device such as a computer system or associated with the instruction execution system, apparatus or device such as a computer system.

Where necessary, the different functions provided here can be executed in different sequences and/or in parallel to each other. Besides, one or more of the above functions may be alternative or combined where necessary.

Although various aspects of the present invention are described in the independent claims, other aspects of the present invention comprise other combinations of features from the embodiments and/or dependent claims having a characteristic of an independent claim, not merely comprising the combination of explicit disclosure in the claims.

Here, it should be further noted that although the exemplary embodiments of the present invention have been described above, these descriptions should be regarded as limitation. On the contrary, various transformations and modifications are allowed without departing from the scope of the present invention as limited in the appended claims.

1. A method for operating a wireless access point apparatus in a multi-point coordination system of a heterogeneous network, comprising:
obtaining all pathlosses PL₁, . . . , PLₙ of all coordination pico wireless access points in a coordination set of a user equipment;
obtaining a real pathlosss PL₀ from the user equipment to a macro wireless access point;
calculating a virtual pathloss PL′₀ from a virtual user equipment corresponding to the user equipment to the macro wireless access point based on the obtained respective pathlosses PL₀ and PL₁, . . . , PLₙ;
informing the user equipment of information related to the calculated virtual pathloss PL′₀.

2.-4. (canceled)

5. The method according to claim 1, wherein the virtual pathloss PL′₀ may be expressed as:
PL′₀=ƒ(PL₀,PL₁, . . . PLₙ)
wherein the function ƒ(·) is dependent on a specific multi-point coordination processing algorithm for the user equipment in the multi-point coordination system.

6. The method according to claim 1, wherein the calculating step further comprises:
calculating a relative value between a virtual pathloss PL′₀ and a real pathlosss PL₀;
wherein the information related to the calculated virtual pathloss PL′₀ includes the relative value.

7. The method according to claim 6, wherein the relative value comprises a value β representing a ratio relationship between the real pathloss PL₀ and the virtual pathloss PL′₀.

8. The method according to claim 7, further comprising: calculating, based on the value β representing a ratio relationship between the real pathloss PL₀ and the virtual pathloss PL′₀, a virtual UE-specific offset component P_{0U}′=P_{0U}+α·(β−1)·PL₀ of a base level P₀, wherein α denotes a pathloss compensation factor,
wherein the virtual UE-specific offset component P_{0U}′ is informed to the user equipment via a higher-layer signaling.

9. The method according to claim 7, further comprising: calculating, based on the β value representing a ratio relationship between the real pathloss PL₀ and the virtual pathloss PL′₀, a virtual closed-loop power control correction value δ′=δ+α·(β−1)PL₀, wherein α denotes a pathloss compensation factor,
wherein the virtual closed-loop power control correction value δ′ is informed to the user equipment via a dynamic signaling.

10. The method according to claim 6, wherein the relative value comprises a value Δ representing a difference relationship between the real pathloss PL₀ and the virtual pathloss PL′₀.

11. The method according to claim 10, further comprising: calculating, based on the value Δ representing a difference relationship between the real pathloss PL₀ and the virtual pathloss PL′_{O}, a virtual UE-specific offset component P_{0U}′=P_{0U}+α·Δ of a base level P₀, wherein α denotes a pathloss compensation factor,
wherein the virtual UE-specific offset component P_{0U}′ is informed to the user equipment via a higher-layer signaling.

12. The method according to claim 10, further comprising calculating, based on the value β representing a ratio relationship between the real pathloss PL₀ and the virtual pathloss PL′_{O}, a virtual closed-loop power control correction value δ′=δ+α·Δ, wherein α denotes a pathloss compensation factor,
wherein the virtual closed-loop power control correction value δ′ is informed to the user equipment via a dynamic signaling.

13.-23. (canceled)

24. A wireless access point apparatus in a multi-point coordination system of a heterogeneous network, comprising:
an obtaining module for obtaining all pathlosses PL₁, . . . , PLₙ of all coordination pico wireless access points in a coordination set of a user equipment and obtaining a real pathlosss PL₀ from the user equipment to a macro wireless access point;
a calculating module for calculating a virtual pathloss PL′₀ from a virtual user equipment corresponding to the user equipment to the macro wireless access point based on the obtained respective pathlosses PL₀ and PL₁, . . . , PLₙ;
an informing module for informing the user equipment of information related to the calculated virtual pathloss PL′₀.

25.-27. (canceled)

28. The wireless access point apparatus according to claim 24, wherein the virtual pathloss PL′₀ may be expressed as:
PL′₀=ƒ(PL_{O},PL₁, . . . PLₙ)
wherein the function ƒ(·) is dependent on a specific multi-point coordination processing algorithm for the user equipment in the multi-point coordination system.

29. The wireless access point apparatus according to claim 24, wherein the calculating module is further configured to calculate a relative value between a virtual pathloss PL′₀ and a real pathlosss PL₀;
wherein the informing module is configured to inform the user equipment of the relative value.

30. The wireless access point apparatus according to claim 29, wherein the relative value comprises a value β representing a ratio relationship between the real pathloss PL₀ and the virtual pathloss PL′₀.

31.-32. (canceled)

33. The wireless access point apparatus according to claim 29, wherein the relative value comprises a value Δ representing a difference relationship between the real pathloss PL₀ and the virtual pathloss PL′₀.

34.-35. (canceled)

36. A user equipment in a multi-point coordination system of a heterogeneous network, comprising:
a receiving module for receiving information related to a virtual pathloss PL′₀ from a wireless access point acting as a scheduling network element;
a power control module for performing power control using uplink open-loop power control parameters for a macro wireless access point based on the information related to the virtual pathloss PL′₀.

37.-47. (canceled)
